(19) United States
(12) Patent Application Publication
(10) Pub. No.: US 2004/0071869 A1
(43) Pub. Date: Apr. 15, 2004

(54) METHOD OF COATING A TAPE MEASURE BLADE

(76) Inventors: Edgar T. Gilliam, Franklinton, NC (US); James M. Critelli, Fuquay-Varina, NC (US)

Correspondence Address: COATS & BENNETT, PLLC, P O BOX 5, RALEIGH, NC, 27602, US

(21) Appl. No.: 10/268,432

(22) Filed: Oct. 10, 2002

(51) Int. Cl. B05D 1/12

(52) U.S. Cl. 427/180; 427/458

(57) ABSTRACT

A metallic tape blade may be substantially coated with a powder and then passed through an induction unit to heat the powder and form a coating on the blade, with the blade having a concavo-convex cross-section when passing through the induction unit. Alternatively, the metallic tape blade is substantially covered with a powder consisting essentially of nylon having a particle size of 20 microns or less and then passed through an induction unit to heat the blade and form a nylon coating derived from the powder thereon. Alternatively, a nylon coating is applied to the metallic tape blade, with the coating having a thickness of not more than 0.0015 inches and an abrasion resistance according to ASTM D968-81 of at least 30 liters of sand. One or more of these aspects may be combined to form a tape blade having a protective coating thereon.

### FIELD OF THE INVENTION

The present invention is directed generally to tape measures and, more particularly, to a coated tape measure blade and a method of making the same.

### BACKGROUND OF THE INVENTION

Modern power return tape measures (or “tape rules”) typically include a coiled tape that is spring-biased towards a retracted position. A housing generally surrounds protects the tape and biasing spring and includes an opening through which a distal end of the tape extends. The distal end of the tape is pulled away from the housing during use, and when released, the spring pulls the tape back into the housing so that the tape returns to the retracted position.

The tape blades for such devices are typically formed from a metal ribbon that assumes a concavo-convex configuration when outside the housing, but that is wound into a revolute coil inside the housing with each layer of the coil having a flat cross-section. While the base material of the blade is typically metal, the surface of the blade material is rarely bare metal. Instead, the blade material is typically painted, printed with length indicia, and then coated with a polymer coating to improve abrasion resistance and/or reduce friction. This polymer coating is typically applied by passing the ribbon material over a coating roller and then through an oven to cure the coating.

Obviously, increasing the blade coating thickness has the beneficial effect of increasing the abrasion resistance; however, increasing the coating thickness increases also the space consumed by the coiled blade, thereby deleteriously increasing the overall size of the tape measure.

Separately, the conventional technique of applying the polymer coating to the blade material—using a coating roller—has proved somewhat problematic, particularly in forming a coating of a relatively uniform thickness without undesirable voids.

As such, there remains a need for alternative methods of coating a tape measure blade. While it is not required, it is preferred that the alternative methods address one or more of the problems discussed above.

### SUMMARY OF THE INVENTION

The present invention is directed to a coated tape measure blade and a novel method of making the same. In one embodiment of the invention, a metallic tape blade is substantially coated with a powder and then passed through an induction unit to heat the powder and form a coating on the blade, with the blade having a concavo-convex cross-section when passing through the induction unit. In another embodiment, the metallic tape blade is substantially covered with a powder consisting essentially of nylon having a particle size of 10-20 microns or less and then passed through an induction unit to heat the blade and form a nylon coating derived from the powder thereon. In yet another embodiment, a nylon coating is applied to the metallic tape blade, with the coating having a thickness of not more than about 0.001 inches or less per side and an abrasion resistance according to ASTM D968-81 of at least 30 liters, and more preferably at least 40 liters, of sand. In still other embodiments, one or more of these aspects are combined to form a tape blade having a protective coating thereon.

### BRIEF DESCRIPTION OF THE DRAWINGS

FIG. 1 shows a power return tape measure that may employ a tape blade constructed in accordance with the present invention.

FIG. 2 is a perspective view of a concavo-convex tape blade.

FIG. 3 is a cross-sectional view of the tape blade of FIG. 2.

FIG. 4 shows a process line for forming a coating on the tape blade of FIG. 2.

FIG. 5A shows a top view of a coil having a non-circular shape suitable for the induction unit of the process line of FIG. 4.

FIG. 5B shows a side view the coil of FIG. 5A.

### DETAILED DESCRIPTION OF THE INVENTION

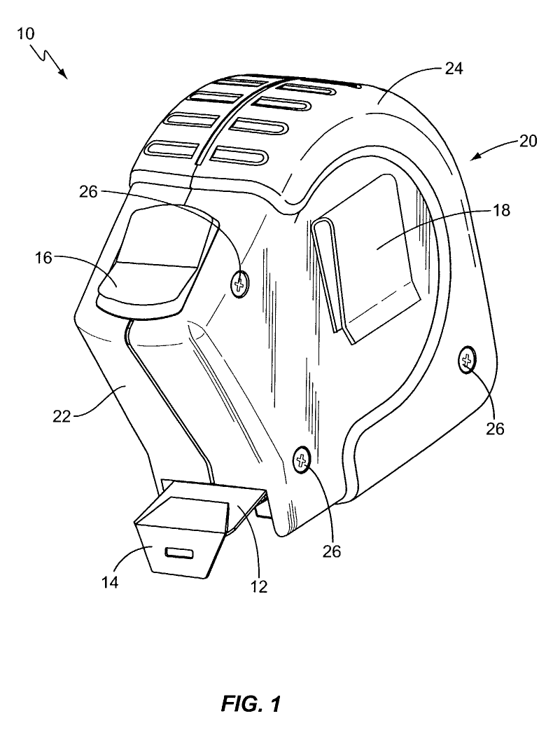

As the present invention relates to a coated tape measure blade, particularly for so-called power return tape measures, a brief discussion of such devices may be helpful in understanding the present invention. As illustrated in FIG. 1, a power return tape measure, generally designated 10, typically includes a coilable measuring tape or blade 12 and an associated housing 20. The distal end of the tape 12 may include an end hook 14 to prevent it from being retracted into the housing 20. A tape-biasing device (not shown), such as a spring, is operatively connected to the tape 12 to bias it towards a retracted orientation. A locking mechanism, including a toggle 16 or similar actuator is provided to aid in controlling the movement of the tape 12 into and out of the housing 20. One or both sides of the housing 20 may include a clip 18, as desired. The housing 20 may include a main case or shell 22 and a grip element 24 mounted on the shell 22. Shell 22 is preferably made from a durable material such as a hardened plastic (e.g., ABS, polycarbonate, or the like) and may be constructed from two portions joined together by suitable screws 26, as is known in the art. The housing 20 is preferably sized to fit within a user's hand, and also conveniently stored on a work belt or in a toolbox. As the present invention primarily relates to the tape blade 12, additional details of the construction of the tape measure 10 are not necessary for one of ordinary skill in the art to understand the present invention. If additional details are desired, see U.S. Pat. Nos. 4,527,334; 4,976,048; 6,349,482, and U.S. patent application Ser. No. 10/174,629, filed Jun. 19, 2002, which are incorporated herein by reference.

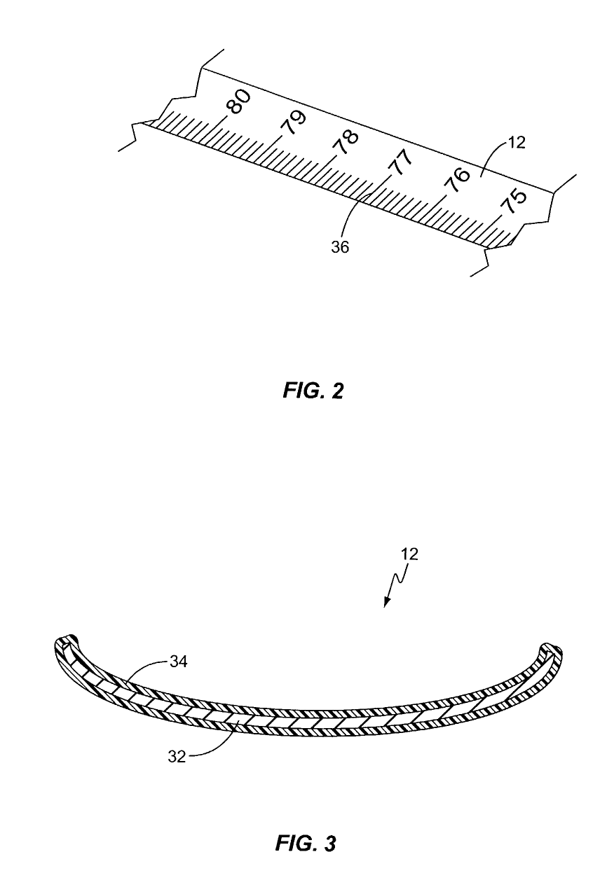

The tape blade 12 is typically formed from a relatively thin metal ribbon 32 shaped to form the desired concavo-convex cross-sectional shape (as shown in FIGS. 2-3) when extended from the housing 20, and the desired flat cross-section when coiled inside the housing 20. The underlying metal ribbon 32 is typically a steel alloy, such as medium to high carbon steel (e.g., 1095 steel or 1050 steel), with a thickness in the general range of 0.004 to 0.0055 inches. While not required, the ribbon 32 forming the core of the tape blade 12 preferably has a uniform thickness across its width and along its length. The ribbon material itself may be formed into the desired shape using any one of a variety of known techniques, such as roll forming. The metal ribbon 32 is typically painted and then printed with appropriate length indicating indicia 36 using known techniques. Thereafter, the printed tape blade 12 is coated with a suitable protective coating 34. The purpose of the coating 34 is to increase abrasion resistance and/or to provide a low friction surface to aid in coiling the blade 12.

The present invention relates to one or more methods of coating the tape blade 12, and preferably the painted and printed tape blade 12. As such, the discussion will assume that the tape blade 12 is painted and printed with the length indicating indicia 36 prior to the coating process, but this is not strictly required for all embodiments.

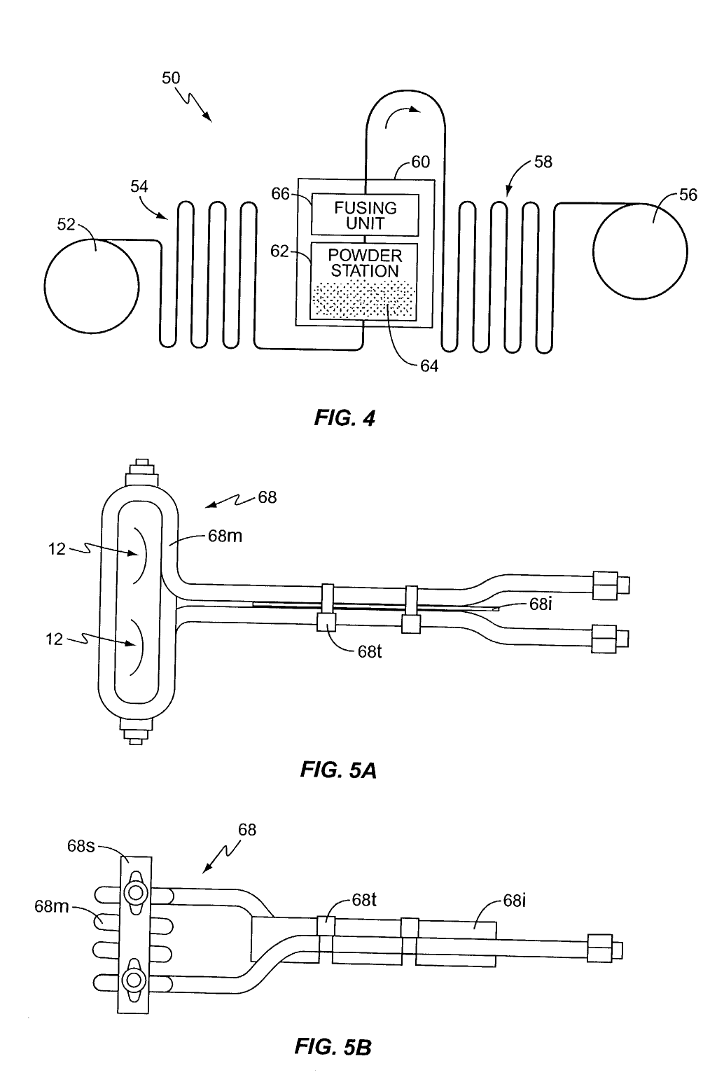

The coating process may take place at a coating process line 50, such as that shown in FIGS. 4-5. The coating process line 50 typically includes a let-off station 52, a coating station 60, and a take-up station 56. The let-off station 52 operates in a 10 conventional fashion to supply the painted and printed tape blade material 12 to the coating station 60, and the take-up station 56 operates in a conventional fashion to receive the coated tape blade 12 from the coating station 60. Further, it may be advantageous to include suitable accumulators 54,58 on the input and/or output portions of the process line 50 so that the tape blades 12 may be supplied to the coating station 60, and output therefrom, in the form of rolls of concatenated blades (e.g., multiple blades 12 riveted end to end), as is known in the art.

For the preferred embodiments of the invention, one primary difference with the prior art coating processes lies in the use of a novel process within the coating station 60. As shown in FIG. 4, the coating station 60 has two principle components—the powder unit 62 and the fusing unit 66. The powder unit 62 applies a polymer based powder 64 to the ribbon 32; this powder 64 is subsequently fused into a coating 34 in the fusing unit 66. In the powder unit 62, the ribbon 32 is routed through a vortex of polymer particles 64 that have been triboelectically charged. The particles themselves are preferably nylon, more particularly nylon 11 with a particle size of 10-20 microns or less, and preferably 15 microns or less. Such nylon should be commercially available from Atofina Chemicals of Philadelphia, Pa. The triboelectric charge is applied by agitating the powder 64 using one or more blowers (not shown), such as the triboelectric powder spray gun of the type generally described in U.S. Pat. No. 5,402,940, which is incorporated herein by reference. The mixing action of the powder 64 causes a positive static electricity charge (sometimes referred to as a triboelectric charge) to build up. The tape blade 12 is grounded, such as by grounding a feed roller immediately upstream of the powder unit 62, giving the tape blade 12 a relatively negative charge (with respect to the powder 64) so that the powder particles 64 are attracted to the blade 12. The combination of the very small particle size of the powder 64 and the triboelectric charging is believed to help form a uniform layer of powder 64 on the ribbon 32. In addition, because a vortex of powder 64 is used, rather than a roller, the ribbon 32 may optionally have its “normal” concavo-convex cross-sectional shape while passing through the powder unit 62.

A powder unit 62 for use with the present invention may be formed using a number of off-the shelf components supplied by Nordson Corp. of Amherst Ohio. For instance, a triboelectric powder spray gun of part numbers 631201, 631271, 630008, and 133403 may be used in conjunction with a model 163567 hopper having a model 631401/163555 “tribo pump” and a model 631152 control unit. The powder 64 in the hopper is preferably in the form of a fluidized bed of powder that is pumped to the triboelectric powder spray gun by the tribo pump. The output of the triboelectric powder spray gun is fed to a generally cylindrical vortex tower tangent to the outer wall thereof. In the vortex tower, half the input of charged powder 64 is directed along the inside of the outer wall, and half the input is deflected by an internal deflector towards a point approximately 180° away from the input point. The vortex tower may be made from PVC, be approximately eight inches in diameter and approximately eighteen inches tall. The bottom of the vortex tower may be tilted towards an exhaust port leading to filter for pulling powder laden air out of the vortex tower for recycling to the hopper. The hopper may also be vented via a hose that lead to the vortex tower, with an input port approximately 6 inches below the input from the triboelectric powder spray gun and offset by approximately 90°. The bottom of the vortex tower should have a slit cut therein to allow for the passage of the blades 12 being processed. This slit may optionally be faced with soft bristles to help prevent unwanted escape of powder 64 from the vortex tower.

From the powder unit 62, the powdered ribbon 32 proceeds, preferably directly, to and through the fusing unit 66. While traditional coating furnaces are either electrical resistance heaters (or more rarely gas-fired ovens), the fusing unit 66 for the present invention is preferably based on the induction principle wherein a time-varying electromagnetic field is applied to the blade 12 via coil 68. In preferred embodiments, the electromagnetic field has a frequency of approximately 450 kHz. Such an electromagnetic field causes the metallic ribbon 32 to heat up very quickly and substantially uniformly. Additionally, the use of induction heating allows the blade 12 to have its “normal” concavo-convex cross-sectional shape while passing through the fusing unit 66 at a high line speed (e.g., forty to sixty feet per minute) without adverse coating effects proximate the lateral edges of the blade 12. The heat from blade 12 causes the powder 64 to fuse, forming the preferably transparent coating 34 on the painted and printed blade 12. The blade 12 then passes outside the fusing unit 66 for cooling. Note that it is preferred that the blade 12 not encounter any rollers or other guides, either while passing through the fusing unit 66, or immediately thereafter, until the coating 34 has cooled sufficiently; however, if desired, the first roller downstream from the fusing unit 66, typically disposed ten feet or more downstream, may be so-called cooling roller to additionally cool the blade 12. The final coating thickness should be on the order of 0.001 inches or less on a given side of the blade 12.

As described above, the preferred fusing unit 66 utilizes the induction heating principle. The relevant electromagnetic field is generated by passing electricity through a coil 68, with the blade 12 passing through the central opening in the coil 68. Preferably, the coil 68 has a non-circular shape, such as that shown in FIGS. 5A-5B. As shown in FIGS. 5A-5B, the coil 68 may include a main coil section 68m with spaced windings supported by stabilizer 68s and leads that are insulated from one another by insulator 68i and held together by ties 68t. The coil 68 may be formed from ¼ inch cooper tubing, coated with suitable ceramic coatings. The coil may have a generally oval center opening with an inner dimension of approximately 3½ inches by ¾ inches, as shown in FIGS. 5A-5B. Indeed, if the coil 68 is in the shape shown in FIGS. 5A-5B, two or more blades 12 can be passed through the coil 68 simultaneously without adversely affecting the fusing operation. Of course, additional let-offs 52 and take-ups 56, etc. may be required if more than one tape blade 12 is to be coated simultaneously using the same coating station 60. Further, the required power for the induction coil 68 will vary based on process conditions, but a coil 68 of 5 KW running at about 60% is believed sufficient for operations with two blades 12 passing through the induction unit 66 simultaneously at a line speed of 40-60 feet/minute.

It should be noted that the fusing unit 66 using the induction principle is capable of generating significant heat in the blade 12, and may even entirely melt the blade 12 if the blade 12 stops while in the fusing unit 66. Accordingly, it may be advantageous to incorporate suitable automatic systems that shutoff the coil 68 when line speed drops below a given level, such as line speed monitors and switches, etc. known in the art. In addition, other suitable safety measures known in the art may be employed, such as out-gas exhausting of the induction unit 66, flame detectors aimed at the coil 68, and the like.

One of the purposes of applying a coating 34 to the tape blade 12 is to increase the life of the blade 12. As known in the art, one useful predictor in estimating blade 12 life is the measured abrasion resistance when tested according to ASTM D968-81. The results of such testing are usually expressed as an amount of falling sand (e.g., X liters of sand) until failure is detected. Most, if not all, commercially available power return tape blades have a reading of less than twenty liters of sand using this test method. In contrast, tape blades 12 processed according to the process outlined above have a measured abrasion resistance of at least thirty liters of sand, with values of forty liters, fifty liters, or seventy-five liters of sand or more being more typical. Indeed some test results have exceed one hundred liters of sand. Thus, processing the tape blades 12 according to such a process is believed to lead to substantially improved blade life, even with relatively thin (e.g., approximately 0.001 inch thick) coatings 34.

The present invention may, of course, be carried out in other specific ways than those herein set forth without departing from the essential characteristics of the invention. Just by way of non-limiting example, the length indicating indicia 36 on the tape blade 12 may be embossed, rather than printed, without deviating from the scope of the present invention. The present embodiments are, therefore, to be considered in all respects as illustrative and not restrictive, and all changes coming within the meaning and equivalency range of the appended claims are intended to be embraced therein.

What is claimed is:

1. A method of coating a tape measure blade, comprising:
providing a metallic ribbon with length indicating indicia thereon;
thereafter, substantially covering at least a segment of said ribbon with a powder;
thereafter, passing said segment with said powder thereon through an induction unit to heat said segment and thereby form a coating from said powder on said segment, said segment having a concavo-convex cross-section when passing through said induction unit.

2. The method of claim 1 wherein said powder is a polymer.

3. The method of claim 2 wherein said powder comprises nylon.

4. The method of claim 3 wherein said powder consists essentially of nylon having a particle size of 20 microns or less.

5. The method of claim 1 wherein said coating is substantially transparent.

6. The method of claim 1 further comprising triboelectrically charging said powder and wherein said substantially covering said segment with said powder comprises exposing said segment to said powder when said powder is triboelectrically charged.

7. The method of claim 1 wherein passing said segment with said powder thereon through said induction unit to heat said segment comprises passing said segment with said powder thereon through an induction unit having a non-circular coil.

8. The method of claim 1 wherein said coating has an abrasion resistance according to ASTM D968-81 of at least 30 liters of sand.

9. The method of claim 1:
wherein said powder consists essentially of nylon having a particle size of 25 microns or less;
wherein passing said segment with said powder thereon through an induction unit comprises passing said segment with said powder thereon through an induction unit having a non-circular coil; and
wherein said coating is substantially transparent.

10. The method of claim 9 further comprising triboelectrically charging said powder and wherein said substantially covering said segment with said powder comprises exposing said segment to said powder when said powder is triboelectrically charged.

11. A method of coating a tape measure blade, comprising:
providing a metallic ribbon with length indicating indicia thereon;
thereafter, substantially covering at least a segment of said ribbon with a powder, said powder consisting essentially of nylon having a particle size of 20 microns or less; and
thereafter, passing said segment with said powder thereon through an induction unit to heat said segment to form a nylon coating from said powder thereon.

12. The method of claim 11 wherein said passing said segment with said powder thereon through an induction unit comprises passing said segment with said powder thereon through an induction unit having a non-circular coil.

13. The method of claim 11 wherein said coating is substantially transparent.

14. The method of claim 11 further comprising triboelectrically charging said powder and wherein said substantially covering said segment with said powder comprises exposing said segment to said powder when said powder is triboelectrically charged.

15. The method of claim 11 wherein said passing said segment with said powder thereon through an induction unit comprises passing said segment with said powder thereon through an induction unit with said segment having a concavo-convex cross-section when passing through said induction unit.

16. The method of claim 11 wherein said coating has an abrasion resistance according to ASTM D968-81 of at least 30 liters of sand.

17. The method of claim 16 wherein said coating has an abrasion resistance according to ASTM D968-81 of at least 40 liters of sand.

18. The method of claim 11:
wherein said segment has a concavo-convex cross-section when passing through said induction unit;
wherein passing said segment with said powder thereon through an induction unit comprises passing said segment with said powder thereon through an induction unit having a non-circular coil; and
wherein said coating is substantially transparent.

19. The method of claim 18 further comprising triboelectrically charging said powder and wherein said substantially covering said segment with said powder comprises exposing said segment to said powder when said powder is triboelectrically charged.

20. The method of claim 11 wherein said powder consists essentially of nylon having a particle size of 15 microns or less.

21. A method of coating a tape measure blade, comprising:
providing a metallic tape measure blade with length indicating indicia thereon;
applying a nylon coating to at least a segment of said ribbon, said coating having a thickness of not more than 0.0015 inches and an abrasion resistance according to ASTM D968-81 of at least 30 liters of sand.

22. The method of claim 21 wherein said abrasion resistance is at least 40 liters of sand.

23. The method of claim 22 wherein said abrasion resistance is at least 50 liters of sand.

24. The method of claim 23 wherein said abrasion resistance is at least 75 liters of sand.

25. The method of claim 21 wherein said thickness is approximately 0.001 inches or less and said abrasion resistance is at least 40 liters of sand.

26. The method of claim 21 wherein said coating is substantially transparent.

27. The method of claim 21 wherein applying said coating comprises:
substantially covering said segment with a nylon powder;
thereafter, passing said segment with said powder thereon through an induction unit.

28. The method of claim 27 wherein said passing said segment with said powder thereon through an induction unit comprises passing said segment with said powder thereon through an induction unit with a concavo-convex cross-section.

29. The method of claim 27 further comprising triboelectrically charging said powder and wherein said substantially covering said segment with said powder comprises exposing said segment to said powder when said powder is triboelectrically charged.

30. The method of claim 21:
wherein said segment has a concavo-convex cross-section when passing through said induction unit;
wherein applying said coating comprises substantially covering said segment with a nylon powder and thereafter passing said segment with said powder thereon through an induction unit having a non-circular coil;
wherein said coating is substantially transparent; and
wherein said abrasion resistance is at least 50 liters of sand.

31. The method of claim 29 wherein said powder consists essentially of nylon having a particle size of 20 microns or less.
